(19) United States
(12) Patent Application Publication
(10) Pub. No.: US 2017/0016512 A1
(43) Pub. Date: Jan. 19, 2017

(54) FASTENER FOR MECHANICALLY LINKED CONVEYOR BELTS

(71) Applicant: Volodymyr KOVALCHUK, Odesa (UA)

(72) Inventors: Volodymyr KOVALCHUK, Odesa (UA); Volodymyr BEREZHYNSKYI, Donetsk (UA); Volodymyr HANZIUK, Kyiv (UA)

(21) Appl. No.: 15/037,398

(22) PCT Filed: Nov. 17, 2014
(86) PCT No.: PCT/UA2014/000124

§ 371 Date: May 18, 2016

(30) Foreign Application Priority Data
Nov. 19, 2013 (UA) A 2013 13457

(51) Int. Cl. F16G 3/08

(52) U.S. Cl. CPC F16G 3/08

(57) ABSTRACT

Fastener for the mechanical jointing of conveyor belts comprises two plates and two connecting elements, each plate has two identical through holes arranged as concave toward the inner surface of the plate and lugs for fixing to the surface of the conveyor belt, each connecting element is arranged in the form of a bolt the head of which corresponds to the fit socket of the upper plate. Both plates are flat with bosses in cylindrical form at the ends for compressing the conveyor belt ends in butt joint, the diameter of the bosses is larger than the width of the plate also having shaped bosses for fixation with conveyor belt placed in circular section by straight sections of its inner surface, each plate at circular sections is provided with holes arranged symmetrically between the profiled bosses, in the bottom plate both through holes are arranged with threading for a bolt.

The invention relates to conveyor transportation equipment, and specifically to belt conveyors, and can be used in open-pit as well as in underground mining operations, including coal mining operations hazardous by gas and dust factors.

Well-known are the rubberized conveyor belts' fasteners containing two profiled plates with a single centrally positioned bolt. Such fasteners include, particularly, the PWS fastener (refer to the Patent UA No 84325, IPC E21F 13/08, published on Oct. 10, 2013, Bull, No 19), and the Stoke fastener (refer to the Patent UA No 23260, IPC 1365G 15/30, published on Oct. 5, 2007, Bull. No 6)

The disadvantages of such fasteners relate to the need for a longer time required to join the belts' ends that this construction used at practical mining industry, especially at high output producing mines, is of essential importance.

Well-known is the conveyor belts' mechanical fastener “Vymysluvka”, manufactured by “Beshtak” company, Poland (refer to the Patent UA No 23260, IPC V65G 15/30, published on Oct. 5, 2007, Bull. No 6). This fastener consists of an upper and a lower profiled plates, every plate containing two centrally arranged through-holes at the profiled concave-convex oval end portions, shaped as sectors and joined by bolts; at that the lower profiled plate's outer surface bears a receiving hole to fix the head of fastener which has a locking element and a conically-shaped tip; the upper and lower profiled plates oval end portions' flanges bear cutouts which form projecting points in such a way that the bottom plate profiled cutouts are located asymmetrically to those profiled in the upper plate.

Thus the fastener includes two profiled clamping plates with oval ends, at that the rounded portion diameter is greater than the plate's middle part width. Each oval portion contains a central through hole. The plates are convex-shaped and adjacent to the surface of conveyor belt connection joint outer covers (working and running) with their cutout-profiled flanges containing bosses at that the flanges' ends are chamfered relative to the cover bed plane. Each plate's oval portion-located central hole bears on the outer side a centered depression, i.e. so-called fit socket. Each plate's both holes are arranged on the plate's longitudinal centerline. The top plate depressions include hexagonal holes preventing from nut spinning. The plates are compressed with bolts which heads seated at corresponding depressions do not protrude beyond the bottom plate's outer surface. When plates fixing the bolts are tightened with their nuts using a special key, the Alan wrench, whose hexagonally shaped tool enters a corresponding groove positioned in the bolt head center. To secure a reliable conveyor belt ends' connection, both fastener plates bear serration teeth protruding towards each other, in such a way that their sharp ends are pressed into the belt working and running covers' rubber when butt joint mounting. At that the overlaid belt end's running cover and the underlaid belt end's working cover shall be removed when joint assembling prior to install the fasteners. Before installing fasteners of this structural design, the joined belt ends are perforated to arrange sockets for fixing bolts; passage. After plates tightening, the assemblage is finalized with breaking off the bolt's end protruding over the nut face plane.

The known design weaknesses:
The strength of conveyor belts' connection joints even when this technique applied to low resistance power belts,—up to 1250 N/mm,—is sufficient only to allow the joint tensile strength (exceeding 40% of the belt's strength) under joints establishing for emergency repair and is never sufficient for a sustainable operation;
When multiple fasteners forming such joint, on the working cover's surface between these fasteners there appears projections and depressions, thus rendering the conveyor belt surface uneven and susceptible to cover rapid wear;
The profiled plates' teeth accelerate the rubber covers' degradation;
Due to this fastener structural design complexity, particularly to the profiled plates' elaborated shape, the construction cost increases as well as its fabrication laboriousness;
Lack of reliability in fixing the nut's position at the upper plate results in nut spinning around its axis, that sequentially prevents from bolt complete tightening;
The need to use four pieces when installing the fastener parts and both profiled plates' visual similarity increases the assemblage delay.

The known belt fastener was selected as the closest analogue. Both this closest analogue and the claimed utility model have the following common features:
structurally they comprise two profiled plates with two bolts;
each of these plates has two centrally positioned through-holes;
the plate's inner surface adjacent to the conveyor belt covers, bear the clamping elements;
the connecting element is shaped as a bolt, which head enters the upper plate's fit socket and contains a groove for screwing.
   The invention basic task encompassed to creating a strong, reliable, simple and inexpensive fastener design for mechanical joining of rubber-textile conveyor belts, allowing to reduce the assembling time while increasing joints strength and maintaining the conveyor belt surface flatness within the connecting joint area.

The stated problem is solved using a robust high-quality fastener PWS OPTIMA for conveyor belt mechanical joining, which structure comprises a set of two plates and the two connecting elements, each of the plates having two identical through holes concave toward the plate's inner surface, and each the connecting element being shaped as a bolt which head corresponds to the upper plate's fit socket, at that each plate has projections fixing it to the conveyor belt surface, and, specifically, both plates are flat and provided at their ends with the cylindrical embossments for joining the conveyor belt ends through connection joint; the embossments' diameter is larger than the width of the plate, also bearing the conveyor belt fixing profiled projections disposed on its inner surface's circular and straight sections; the circular section of each plate is additionally provided with four holes arranged symmetrically between the profiled bosses, and in the bottom plate both through holes are arranged with threading for a bolt.
The claimed invention novelty is that both plates are flat and bear at their ends the cylindrical shape embossments for joining the conveyor belt ends in butt-joint, the embossments' diameter is greater than the width of the plate, also bearing the conveyor belt fixing profiled projections disposed on its inner surface's circular and straight sections; the circular section of each plate is additionally provided with four holes arranged symmetrically between the profiled bosses, and the both through holes in bottom plate are provided with threading for a bolt.

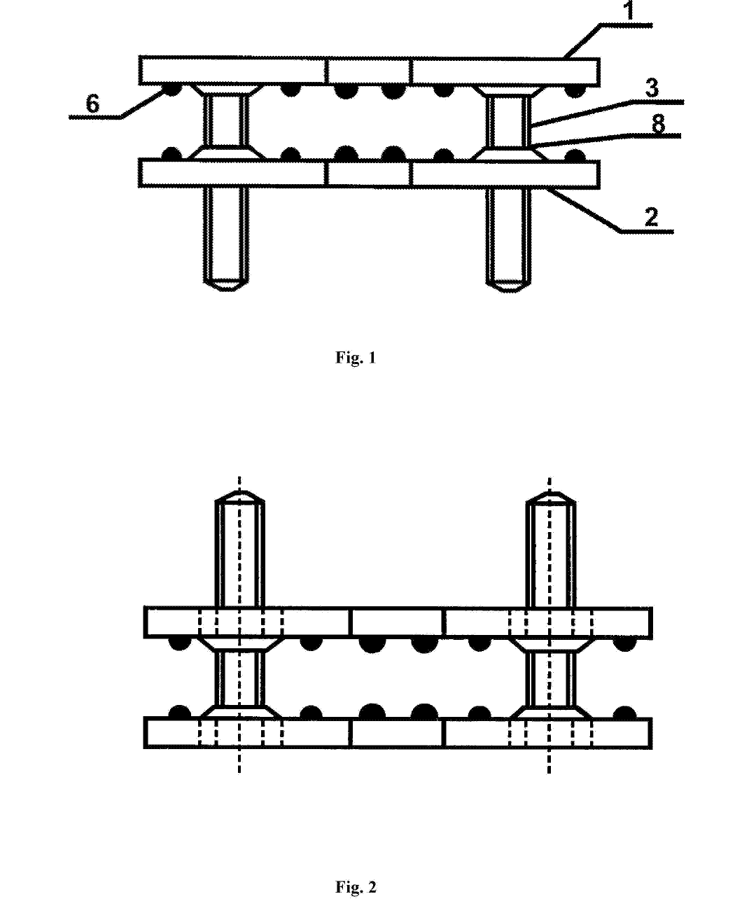

FIG. 1 shows the general view of PWS OPTIMA for conveyor belts mechanical joining.

FIG. 2 represents a lateral view of PWS OPTIMA for conveyor belts mechanical joining.

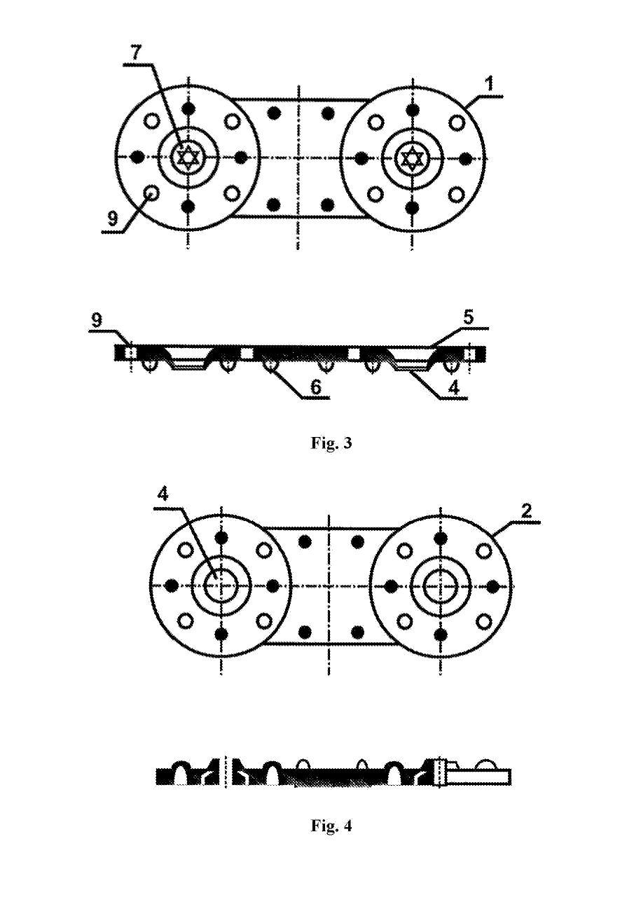

FIG. 3 represents a plan top and lateral view of the upper profiled plate.

FIG. 3 represents a plan top and lateral view of the bottom profiled plate.

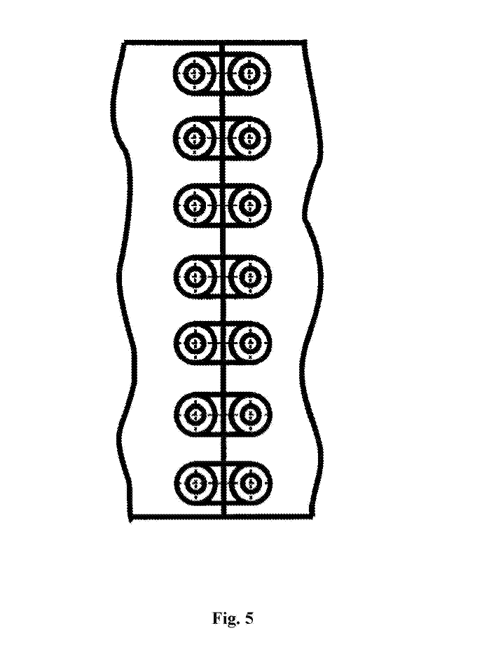

FIG. 5 exposes the linkage between PWS OPTIMA and the conveyor belt. The claimed PWS OPTIMA for conveyor belts mechanical joining (refer to FIG. 1) includes two flat plates upper 1 and bottom 2 and two connecting elements 3, both shaped as a bolt. Plates 1 and 2 have two centerline-arranged through holes 4 for the coupling element 3 (refer to FIGS. 2, 3) configured as a bolt which head corresponds to the receiving hole 5 of the upper plate 1 (refer to FIGS. 3.4). The conveyor belt-facing surface of the upper and lower plates 1, 2 bears profiled projections 6 intended for plates engagement to the conveyor belt. At its end portion the head of bolt 3 has a hexagon socket 7 for the cap wrench. The bottom plate 2 is equipped with thread 8 for tightening bolts 3 (refer to FIG. 4) Each of the plates 1 and 2 bears additional through-holes 9, symmetrically arranged between the profiled protrusions 6.

The connection joint is assembled as follows:
The conveyor belts' ends (refer to FIG. 5), subject to connecting, are cut at an angle of 90° with subsequent stepwise processing, degreasing and preparation for joining. Next, the plate 1 (together with bolt 3, further inserted into the conveyor belt opening) is overlaid onto upper belt side. On the lower conveyor belt side bolt 3 is screwed into the plate 2. Bolt 3 is screwed into the thread 8 located on the plate 2. Next, bolt 3 is further screwed to tighten plates 1 and 2 together. The similar tightening procedure is carried out with the second bolt 3. Thus, all fasteners OPTIMA are installed. The bolted joint assembling is rounded out by breaking off the upper plate bolts' protruding ends.
The claimed technical result consists in following: the suggested PWS design for conveyor belts mechanical connection allows the safe operation of the conveyor at its belt strength up to 1600-2000 N/mm. Through-holes 9 arranged in the plates 1 and 2 allows the conveyor belt working surface penetrating through those holes when PWS pressed against the conveyor belt.

The exposed amount of invention allows achieving the technical result as follows
increase in the rubber conveyor belts' connection joint tensile strength;
decrease in the rubber conveyor belts' connection joint flatness distortion;
shortened PWS montage time, since the lower and upper plates are visually and by-touch easily identifiable due to their different structural characteristics;
sustained conveyor belts joining security and maintained joint integrity due to the fastener's structure specificity: absence of teeth on the plate's surface;
provided possibility to carry out the belt's longitudinal ruptures repair.

1. The fastener for mechanical linking of conveyor belts, structurally comprising a set of two plates and the two connecting elements, each of the plates having two identical through holes concave toward the plate's inner surface, and each connecting element being shaped as a bolt which head corresponds to the upper plate's fit socket, at that each plate has bosses fixing it to the conveyor belt surface, and characterized in that both plates are flat and have at their ends the cylindrical embossments for joining the conveyor belt ends through connection joint; the embossments' diameter is larger than the width of the plate which also has shaped bosses for fixation with conveyor belt placed in circular section and by straight sections of its inner surface; the circular portion of each plate is additionally provided with holes arranged symmetrically between the profiled bosses, and the bottom plate's both holes are arranged with threading for a bolt.
